(19) United States
(12) Patent Application Publication
(10) Pub. No.: US 2025/0125673 A1
(43) Pub. Date: Apr. 17, 2025

(54) Electric Machine Stator with Sealed End Ring

(71) Applicant: BorgWarner Inc., Auburn Hills, MI (US)

(72) Inventors: Steve C. Burton, Anderson, IN (US); James R. Davis, Noblesville, IN (US); Arlen P. Suter, Pendleton, IN (US)

(21) Appl. No.: 18/913,307

(22) Filed: Oct. 11, 2024

Related U.S. Application Data
(60) Provisional application No. 63/589,892, filed on Oct. 12, 2023.
(60) Provisional application No. 63/589,915, filed on Oct. 12, 2023.
(60) Provisional application No. 63/589,931, filed on Oct. 12, 2023.

(51) Int. Cl. H02K 1/18; H02K 3/34; H02K 11/25

(52) U.S. Cl. CPC H02K 1/185; H02K 3/345; H02K 11/25

(57) ABSTRACT

A sealed stator for an electric machine includes a stator core, windings, an end ring, and a sealant, such as a sealing gasket. The stator core includes a plurality of stator slots with axial openings to the slots. The windings are positioned on the stator core and include a plurality of interconnected conductors extending through the plurality of stator slots. The end ring is coupled to the stator core and includes a plurality of openings arranged circumferentially around the end ring, wherein the plurality of openings in the end ring are aligned with the axial openings to the stator slots. The sealant is positioned between the stator core and the end ring and seals the end ring to the stator core.

### CROSS-REFERENCE TO RELATED APPLICATIONS

This patent application claims the benefit of U.S. provisional application No. 63/589,892, filed Oct. 12, 2023, U.S. provisional application No. 63/589,915, filed Oct. 12, 2023, and U.S. provisional application No. 63/589,931, filed Oct. 12, 2023, the entire contents of which are incorporated by reference herein.

### FIELD

The present disclosure relates to the field of electric machines, and more particularly, to devices and methods for cooling electric motors.

### BACKGROUND

For an electric machine with a flooded or immersion stator design where the end turns are flooded with oil for cooling, the interior diameter (ID) of the stator must be sealed to prevent oil from entering the airgap which exists between the stator ID and the rotor outer diameter (OD). Various methods and associated devices have been used in the past for sealing the stator. Unfortunately, these past devices and methods tend to be costly and/or adversely affect performance of the electric machine. For example, some past devices and methods for sealing the ID of the stator shrink the mechanical airgap between the stator and rotor and result in mechanical losses. As another example, some past devices and methods involve the use of a closed slot stator lamination stack, which allows magnetic flux to easily leak across the closed slot opening, thus affecting performance of the electric machine.

Accordingly, it would be advantageous to provide an improved method and system for sealing the inner diameter of an electric machine stator. It would be advantageous if the system and method was relatively inexpensive to implement and did not adversely affect performance of the electric machine.

### SUMMARY

A sealed stator for an electric machine is disclosed herein. In at least one embodiment, the sealed stator includes a stator core, windings, an end ring, and a sealant. The stator core includes a plurality of stator slots with axial openings to the slots. The windings are positioned on the stator core and include a plurality of interconnected conductors extending through the plurality of stator slots. The end ring is coupled to the stator core and includes a plurality of openings arranged circumferentially around the end ring, wherein the plurality of openings in the end ring are aligned with the axial openings to the stator slots. The sealant is positioned between the stator core and the end ring and seals the end ring to the stator core. In at least some embodiments, the sealant may be a sealing gasket

In at least one embodiment, a stator for an electric machine includes a stator core including a plurality of stator slots with axial openings to the stator slots. Windings are positioned on the stator core, the windings including a plurality of interconnected conductors extending through the plurality of stator slots. An end ring is adhesively bonded to the stator core, the end ring comprising a plurality of openings arranged circumferentially around the end ring, wherein the plurality of openings in the end ring are aligned with the axial openings to the stator slots.

In yet another embodiment, a method of making a stator for an electric machine is disclosed. The method of making a stator includes engaging a first side of an adhesive gasket with an end ring or a stator core. The method further includes removing a backing from the second side of the adhesive gasket, and then engaging the second side of the adhesive gasket with either the end ring or stator core that is not engaging the first side of the adhesive gasket. The method further comprises inserting conductors through openings in the end ring and slots in the stator core and connecting ends of the conductors to form stator windings.

Advantageously, the sealed stator disclosed herein allows for cooling oil to contact the full length of the coil and provides for improved cooling of the electric machine. The above described features and advantages, as well as others, will become more readily apparent to those of ordinary skill in the art by reference to the following detailed description and accompanying drawings. While it would be desirable to provide an electric machine and method for production thereof that provides one or more of these or other advantageous features as may be apparent to those reviewing this disclosure, the teachings disclosed herein extend to those embodiments which fall within the scope of the appended claims, regardless of whether they include or accomplish one or more of the advantages or features mentioned herein.

### BRIEF DESCRIPTION OF THE DRAWINGS

FIG. 1 is an insertion-side perspective view of a sealed stator for an electric machine, the sealed stator including an end ring positioned on the insertion-side of the stator core;

FIG. 2 shows the insertion-side perspective view of the sealed stator of FIG. 1 with the stator windings removed to show the end ring positioned on the insertion-side of the stator core;

FIG. 3 is a perspective view of an axially-outward-facing side of the end ring of FIG. 1 in isolation from other components of the stator;

FIG. 4 is an enlarged perspective view of pockets and ribs on the axially-outward-facing side of the end ring of FIG. 3;

FIG. 5 is an enlarged perspective view of chamfers formed around slot openings on the axially-inward-facing side of the end ring of FIG. 3;

FIG. 6 is an enlarged perspective view of a portion of the end ring positioned on the sealed stator of FIG. 2;

FIG. 7 is a plan view of a portion of the end ring of FIG. 1 positioned on the stator core with conductors shown in cross-section and extending through openings in the end ring;

FIG. 8 is an enlarged view of a side of an opening in the end ring of FIG. 7;

FIG. 9 is a cutaway view of the stator conductors and end ring along line IX-IX of FIG. 1;

FIG. 10 is an enlarged view of the dotted line isolation box X of FIG. 9 showing an outer diameter of the end ring on the stator core;

FIG. 11 is an enlarged view of the dotted line isolation box XI of FIG. 9 showing an inner diameter of the end ring on the stator core;

FIG. 12 is flat-pattern illustration of conductors of the stator windings of FIG. 1 on the insertion end of the stator core, the conductors extending through openings in the insertion-side end ring, wherein the conductors are illustrated in linear fashion (as opposed to circumferentially) and the end ring is shown in cross-section;

FIG. 13 is a plan view of a gasket in the form of adhesive tape used to connect the end ring to the stator core in the sealed stator of FIG. 1;

FIG. 14 is an enlarged plan view of a portion of the adhesive tape of FIG. 13;

FIG. 15 is a perspective view of an axially-outward-facing side of a weld-side end ring provided on the sealed stator of FIG. 1;

FIG. 16 is an enlarged perspective view of pockets and ribs on the axially-outward-facing side of the end ring of FIG. 15;

FIG. 17 is a cutaway view of stator conductors extending through the weld-side end ring of FIG. 15;

FIG. 18 is flat-pattern illustration of conductors of the stator windings of FIG. 1 on the weld end of the stator core, the conductors extending through openings in the weld-side end ring, wherein the conductors are illustrated in linear fashion (as opposed to circumferentially) and the end ring is shown in cross-section;

FIG. 19 is a block diagram of a method of making the sealed stator of FIG. 1;

FIG. 20 is an illustration of a sequence of steps for forming the conductor windings for the sealed stator of FIG. 1;

FIG. 21 is an illustration of a horizontal axis manufacturing step for the sealed stator of FIG. 1 prior to application of a filler material;

FIG. 22 is an illustration of a tilted axis manufacturing step during application of the filler material to the weld end of the stator of FIG. 1;

FIG. 23 is an illustration of the position of the weld end during the manufacturing step of FIG. 22; and

FIG. 24 is an illustration of another tilted axis manufacturing step during application of the filler to the insertion end of the stator of FIG. 1.

### DESCRIPTION

An electric machine with a sealed stator is disclosed herein. The sealed stator includes a stator core with a plurality of windings arranged thereon. A first end ring is positioned on an insertion side of the stator core, and a second end ring is provided on the weld side of the stator core. Each end ring includes an inner diameter (ID) and an outer diameter (OD) with a plurality of segments formed around the end ring between the ID and the OD. Each segment is defined by two ribs with a pocket and conductor openings formed therebetween. Each end ring is sealed to the housing with a combination of slot liner material, molded end rings, a gasket adhesive, and an epoxy/varnish filler material. A separator is located between coils of a wound rotor of the electric machine which allows the oil to flow along the complete length of the coil, advantageously cooling the coil.

It will be recognized that the following description of embodiments of the electric machine makes use of relative terms that are dependent on an orientation of the electric machine at a given time (e.g., during manufacture or use of the machine in a vehicle). Accordingly, it will be recognized that many terms of orientation and position as used herein are defined with reference to what may be shown in the drawing and/or other common positions. While efforts have been made herein to reference portions of the electric machine with respect to non-changing features, such as referencing “axial,” “radial” and “circumferential” directions and positions of the stator, it will be recognized that other terms are relative terms that depend on the position of the electric machine. For example, the terms “top” (or “upper”), “bottom” (or lower), “left” or “right” may be used in association with what is shown in a drawing, but such position may switch or change if the electric machine is placed in a different position. As another example, the term “above” references a relative position where one component is vertically higher than another component, and the term “below” references a relative position where one component is vertically lower than another component.

### Stator

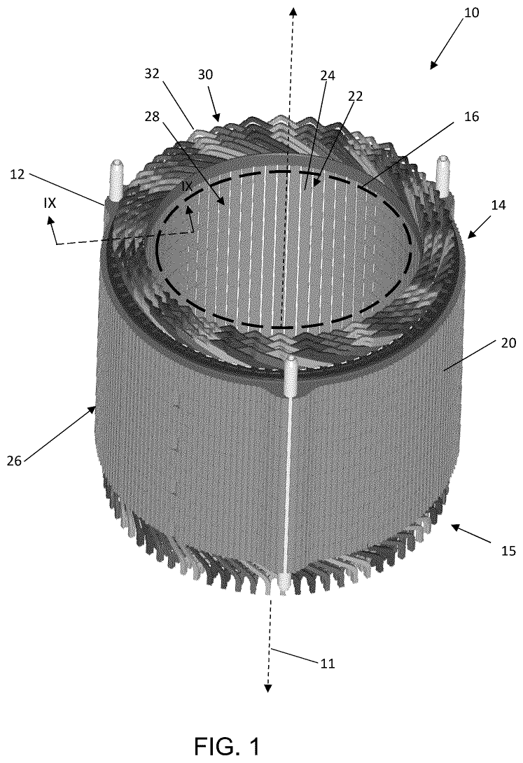

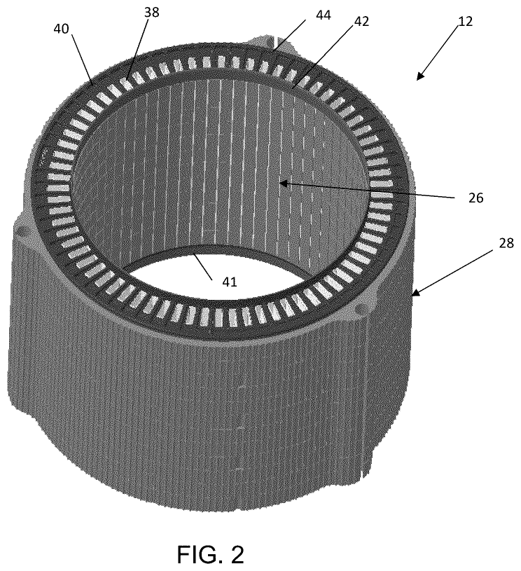

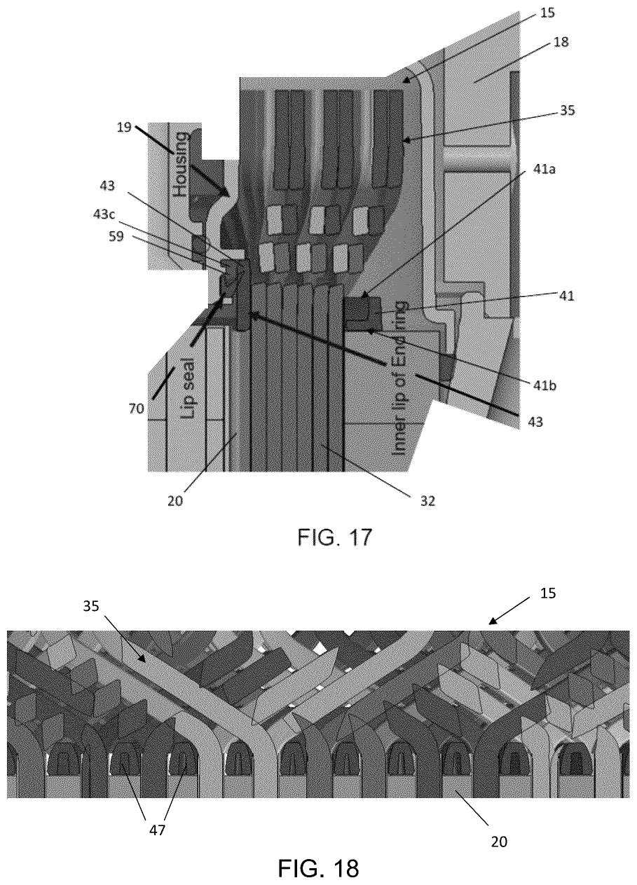

With reference now to FIGS. 1 and 2, an electric machine 10 includes a stator 12 and a rotor 16 (illustrated by dotted lines in FIG. 1). The stator 12 is stationary relative to a housing 18 (not shown in FIGS. 1 and 2; see FIG. 17). The rotor 16 is positioned within the stator 12 and rotatable relative to the stator 12 and the housing 18. An airgap separates the rotor 16 from the stator 12.

The stator 12 includes a stator core 20 with a plurality of stator windings 30 wound on the stator core 20. The stator core 20 is provided by a lamination stack comprised of sheets of magnetic-permeable material, such as steel. In most embodiments, the lamination stack is bonded and not welded. Bonding is advantageous over welding because welds are spaced apart from each other and the area between the welds may tend to bow. Also, the heat of the welding process can sometimes distort the lamination stack. The adhesive also seals the gaps between the laminations. The adhesive used for bonding the laminations may be advantageously applied to the whole surface of the lamination (i.e., full face bonding as opposed to spot bonding).

The stator core 20 is cylindrically-shaped and defines a central axis 11 that is coaxial with a shaft of the rotor 16. An axially-outward direction on the stator 12 is defined as a direction parallel to the central axis 11 and also moving away from a center of the stator core 20; an axially-inward direction on the stator 12 is defined as a direction parallel to the central axis 11 and also moving toward the center of the stator core 20; a radially-inward direction is defined as a direction towards the central axis 11 of the stator core 20; a radially-outward direction is defined as a direction away from the central axis 11; and a circumferential direction is defined is defined as a direction moving around the central axis 11.

The stator core 20 includes a plurality of core slots 22 (or simply “slots”) formed between a plurality of teeth 24. The teeth 24 extend in a radial inward direction from an outer diameter wall 26 of the stator core 20 (which outer surface of the outer diameter wall defines the OD of the stator). The core slots 22 are semi-closed slots (i.e., a small gap is formed between each tooth) that extend radially inward from a segmented circumferential interior surface 28 of the stator core (which circumferential interior surface 28 defines the ID of the stator). The core slots 22 and the teeth 24 also extend in an axial direction, parallel to the central axis 11 of the stator core 20, between a crown end 14 (which may also be referred to herein as an “insertion end”) and a weld end 15 of the stator core (which may also be referred to herein as a “connection end”), the weld end 15 provided on axially opposite end of the stator 12 from the crown end 14. The core slots 22 and the associated teeth 24 are equally spaced around the circumferential inner surface 28 of the stator core 20, and the respective inner surfaces of the teeth 24 extend axially parallel to the central axis 11. A radial opening is provided to each slot 22 between two adjacent teeth 24, wherein the radial opening has a width that is smaller at the inner perimeter surface 28 (i.e., the ID) than at more radially outward positions (i.e., slot positions closer to the OD). Unless I am missing something, the yellow highlights are repeats. In addition to the radial openings to the slots 22 through the inner perimeter surface 28, axial openings to the slots 22 are also provided the opposite ends 14, 15 of the stator core 20.

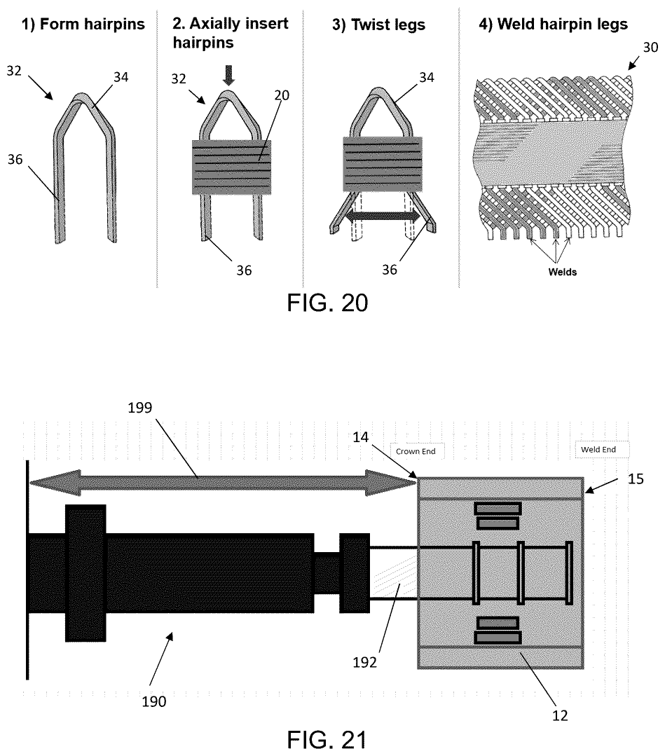

Conductors 32 that form the stator windings 30 are arranged in the slots 22 of the stator core. The conductors 32 that form the stator windings 30 may be, for example, segmented conductors 32 (which may also be referred to as “U-shaped conductors” or “hairpin conductors”), such as those shown in FIG. 20. Each U-shaped conductor 32 includes a U-shaped end turn 34 and two legs 36. The legs 36 of the U-shaped conductors are inserted into the slots 22 of the stator core 20 through the axial openings to the slots. After insertion, the U-shaped end turns 34 are located at the crown end 14 of the stator and the ends of the legs 36 are located at the weld end 15 of the stator. The ends of the legs 36 are interconnected at the weld end 15 to form welded end turns 35 (see FIGS. 17 and 18). The interconnected conductors 32 form windings that wrap around the core 20. Each slot 22 is configured to retain some number of in-slot segments in “layers” of the slot, with the in-slot segments typically arranged in single-file manner such that each layer of the slot retains a single conductor segment. Segmented windings are known for use in preparing stator windings, such as those disclosed in U.S. Pat. No. 7,348,705, issued Mar. 25, 2008, the contents of which are incorporated herein by reference.

Slot liners 38 are positioned in the slots 22 of the stator core 20. The slot liners 38 provide insulation between the conductors 32 and the walls of the slots 22. The slot liners may be provided by any of various materials known to provide insulation for electric machines. For example, the slot liners 38 may be provided by an insulating sheet of material, such as Nomex® paper sold by DuPont, film such as mylar or polyimide, or similar material. Papers such as Nomex can be porous, so for a flooded stator design, an exemplary slot liner material may be either be a 100% film material or a laminate consisting of a layer of paper and a layer of film. The slot liners 38 are provided by forming the sheet into a cylindrical-like structure (having a cross-section that matches the cross-sectional shape of the slot) with two opposing ends of the sheet forming an overlapping structure. For the flooded stator, the seal at the ID is more important than the seal at the OD. Therefore, in the embodiments disclosed herein, the overlap portion is at the back of the slot (i.e., the portion closer to the OD), and the front of the slot (i.e., the portion closer to the ID) is a continuous stretch of the sheet. As shown in FIGS. 6-8, the slot liners 38 line the walls of each slot and extend axially through the slot. The slot liners 38 extend axially out of the slots 22, and into openings 60 in the end rings 40, 41, as explained in further detail below.

Following installation of the windings 30 on the stator core 20, an insulative filler material such as epoxy, varnish (e.g., ELAN-Guard®) or other bonding agent/sealant may be applied to the OD and the ID of the stator core 20, as explained in further detail herein. The filler material provides insulation and sealing features along the OD and ID for an axial length of the stator 12.

### Insertion Side End Ring for Sealed Stator

With reference now to FIGS. 2-12, a first end ring 40 for a sealed stator 12 is disclosed. The end ring 40 provides additional insulation and sealing features on the insertion side of the stator 12. As shown in FIG. 2, the end ring 40 is has a similar shape to the insertion end 14 of the stator core 20 and is designed and dimension to be placed on the insertion end 14 of the stator core 20. The end ring 40 is an insulation member comprised of a polymer or other non-conductive material (the term “non-conductive material” as used herein refers to any of various materials that do not readily conduct electricity and may be used in in electric machines to provide insulation features for the electric machine). In at least one embodiment, the end ring 40 is comprised of a high glass filled plastic (e.g., higher than 30% glass fill, and preferably about 40% glass fill). For example the end ring 40 may be comprised of polyphenylene sulfide (PPS) with 40% glass fill. The end ring 40 is a one-piece component (i.e., a unitary component) wherein all portions of the component are integrally formed and inseparable without destruction of the component (i.e., a monolithic component). Accordingly, the end ring 40 may be formed by an injection molding process, 3D printing, or other process capable of producing such a unitary monolithic component.

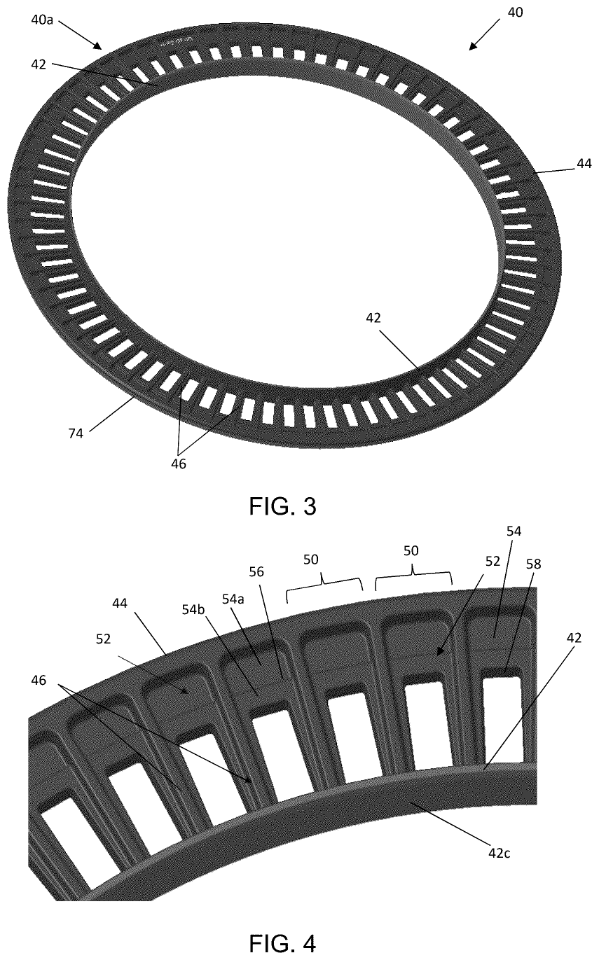

As best shown in FIGS. 3 and 4, the end ring 40 is a disc-shaped member that includes and inner perimeter lip 42 (which may also be referred to as simply an “inner lip”), an outer perimeter edge 44 (which may also be referred to as simply an “outer edge”), an axially-outward-facing side 40a (which may also be referred to herein as a “top side”), and an axially-inward-facing side 40b (which may also be referred to herein as a “bottom side”).

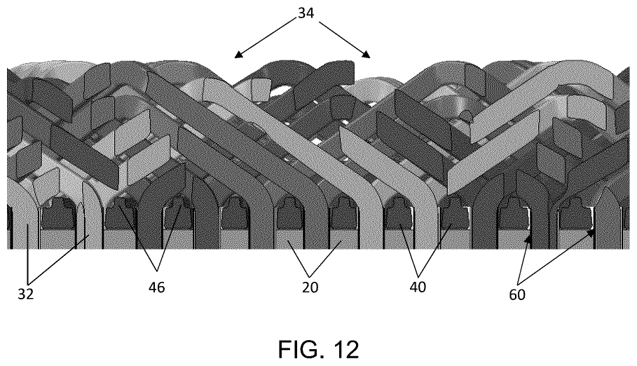

The axially-outward-facing side 40a of the end ring 40 includes a plurality of ribs 46 extending in a radial direction between the inner lip 42 and the outer edge 44. In the disclosed embodiment, the ribs 46 connect the inner lip 42 and the outer edge 44 and split the end ring 40 into a plurality of contiguous (and overlapping) segments 50 arranged circumferentially around the entire circle of the end ring 40. A segment 50 is therefore defined by any two consecutive ribs 46, the circumferential space between the two ribs 46, and the segments of the inner lip 42 and the outer edge 44 bordering such space. Each segment 50 defines a pocket compartment 52 with an outer pocket floor 54 and an inner opening 60 (which may also be referred to herein as simply an “opening”). As explained in further detail below, the outer edge 54 of the end ring has a circular/ring shape and extends axially-outward from the pocket floor 54. Also, conductors 32 of the stator windings 30 are inserted through the openings 60 in the end ring 40 and into the slots 22 in the stator core. As best shown in FIG. 12, the conductors 32 bend around and engage the ribs 46 at the locations where the conductor transitions from the axial in-slot portion to the end turn 34. Accordingly, the ribs 46 prevent over-insertion of the conductors 32 into the slots 22, properly position the conductors at an axial position, and insulate the conductors 32 from the core 20.

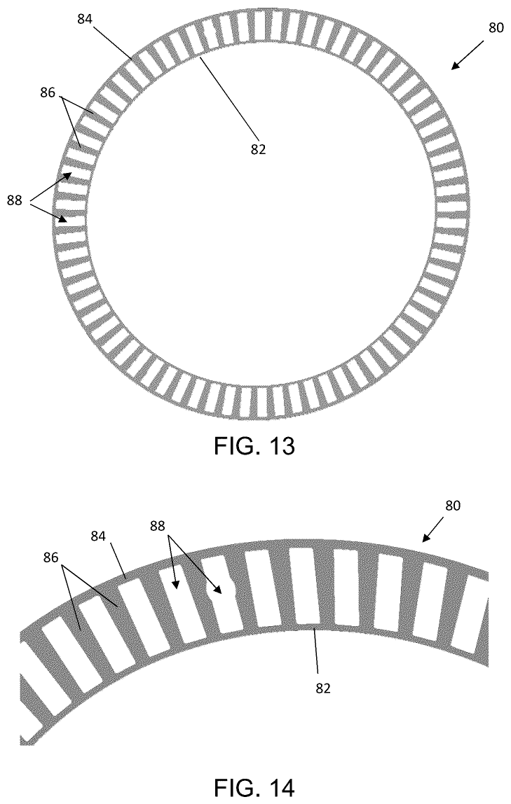

With reference to FIGS. 3, 9 and 11, the inner lip 42 is a generally cylindrical wall member that includes an axially-outward-facing surface 42a (i.e., a top surface), an axially-inward-facing surface 42b (i.e., a bottom surface), a radially inward-facing surface 42c, and a radially-outward-facing surface 42d. The top surface 42a of the inner lip is positioned further outward in the axial direction than any other surfaces of the end ring 40. The bottom surface 42b is co-planar with the bottom surface of the outer edge 44. Accordingly, the distance between the top surface 42a and the bottom surface 42b defines the thickest dimension of the end ring 40 in the axial direction. The bottom surface 42b is also generally flat and smooth and configured to engage a sealant. In at least some embodiments, the sealant is an sealing gasket 80 (which may also be referred to herein as an “adhesive gasket,” and which is also described in further detail below in association with FIGS. 13 and 14).

With continued reference to FIGS. 3, 9 and 11, the radially-inward-facing surface 42c of the inner lip 42 is substantially flat and smooth and configured to engage an inner ring seal 70 (described in further detail below). The top of the radially-inward-facing surface 42c may be tapered slightly outward to assist in the process of sliding the inner ring seal 70 along the ID of the end ring 40 and into position against the inner lip 42. The width of the inner lip 42 as measured from the radially-inward-facing surface 42c to the radially-outward-facing surface 42d is generally less than 4 mm, and about 2.8 mm in the embodiments herein.

The radially-outward-facing surface 42d of the inner lip 42 is also generally flat and smooth, with a few surface features designed to facilitate a good seal between the end ring 40 and the stator core 20. Specifically, a bottom chamfer 62 is formed around the bottom portion of the radially-outward-facing surface 42d. This chamfer 62 is generally angled between about 45° and 75° (e.g., about) 60° relative to the bottom surface 42b, and extends about 0.5 mm to 1 mm upward along the radially-outward-facing surface 42d. This chamfer 62 is designed to assist with insertion of the end ring 40 on the stator core 20 by preventing crumpling of the slot liner 38, which slot liner 38 is designed to engage the relatively flat lower-to-middle portion of the radially-outward-facing surface 42d and extend about 2.8 mm or more upward from the stator core 20. A top portion of the radially-outward-facing surface 42d of the inner lip 42 is tapered slightly inward to limit the contact between the end ring 40 and the conductors 32 of the stator windings 30.

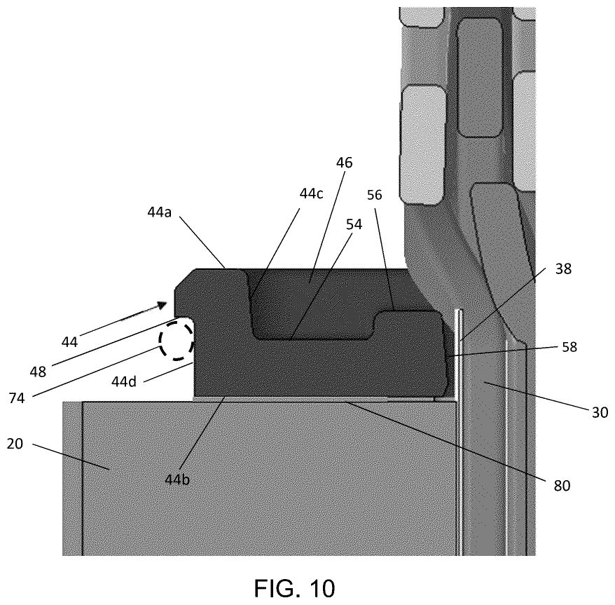

As best shown in FIGS. 3, 9 and 10, the outer edge 44 of the end ring 40 includes an axially-outward-facing surface 44a (i.e., a top surface), an axially-inward-facing surface 44b (i.e., a bottom surface), a radially inward-facing surface 44c, and a radially-outward-facing surface 44d. The top surface 44a of the outer edge 44 is positioned above a pocket floor 54 of the end ring 40. The bottom surface 44b is co-planar with the bottom surface 42b of the inner lip 42. The bottom surface 44b is also generally flat and smooth and configured to engage the sealant/sealing gasket 80. The radially-inward-facing surface 44c of the outer edge 44 has a bottom portion that is substantially flat and smooth, and a top portion that defines an outer lip 48. The outer lip 48 is configured to engage an outer ring seal 74, as explained in further detail below. As best seen in FIGS. 6 and 10 the outer edge 44 and the radial ribs 46 have substantially the same axial height (i.e., the axially-outward-facing surface 44a of the outer edge 44 is at the same axial height as the axially-outward-facing surface of the ribs 46).

With reference now to FIGS. 4-6, each segment 50 on the top side 40a of the end ring 40 defines a pocket compartment 52. The pocket compartments 52 on the top side of the end ring 40 are best shown in FIG. 4. Each pocket compartment 52 includes an outer pocket floor 54 and an inner opening 60. The outer side of the pocket compartment 52 is bounded by the two opposing ribs 46, the inward-facing-surface 44c of the outer edge 44, the pocket floor 54, and a step 56 formed between the pocket floor 54 and the outer side of the opening 60. The opening 60 through the end ring 40 is positioned radially inward from the pocket floor 54. To enable a stator with a short axial height, the pocket floor 54 should have an axial thickness of less than 3.2 mm. The inner side of the pocket compartment 52 includes the opening 60. The opening 60 is bounded between the inner lip 42, the two opposing ribs 46, and an opposing wall 58 to the inner lip 42.

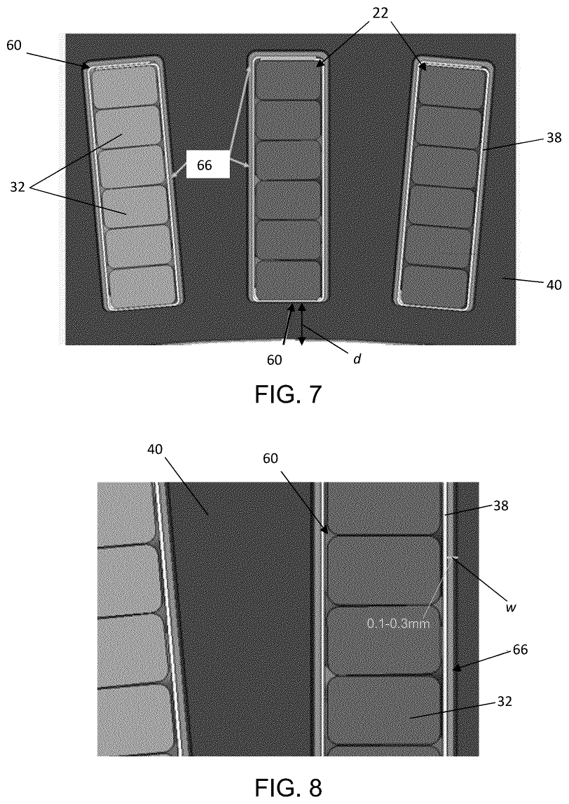

Each opening 60 in a segment 50 of the end ring 40 extends completely through the end ring 40 from the top side to the bottom side. Each opening 60 is dimensioned similar to but slightly larger than the axial openings to the slots 22 in the stator core 20. Accordingly, the openings 60 in the end ring 40 are configured to receive the conductors 32 of the stator windings 30 which also extend through the slots 22 of the core 20, as shown in FIGS. 7 and 8. Because the size of each opening 60 is slightly larger than the size of the associated slot opening, when the end ring 40 is placed on the stator core 20, a cavity 66 (see FIGS. 7 and 8) is formed on the axially-outward-facing side of the end ring between the perimeter of the opening 60 and the conductors 32 extending through the slots. This cavity 66 extends around the entire perimeter of the opening 60. The width across the cavity 66 (i.e., the clearance between the conductors 32 and the perimeter of the opening 60 as indicated by the width w in FIG. 8) is generally in a range between 0.02 mm and 0.7 mm, and typically between 0.1 and 0.3 mm. The smallest cavity width, w, is provided along the inner lip 42. As explained in further detail below, this cavity 66 is filled with insulative filler material during manufacture of the stator 12. The small width w is sufficiently sized to provide capillary action that wicks the insulative filler material (e.g., varnish, epoxy, or other resin material) into the cavity 66, thus sealing the slots 22, as explained in further detail below. Because a seal along the ID of the stator core 20 is particularly valuable, the width w is smallest at the inner lip 42, and the capillary action wicks the filler material into this space between the end ring 40 and the ID of the stator core 20.

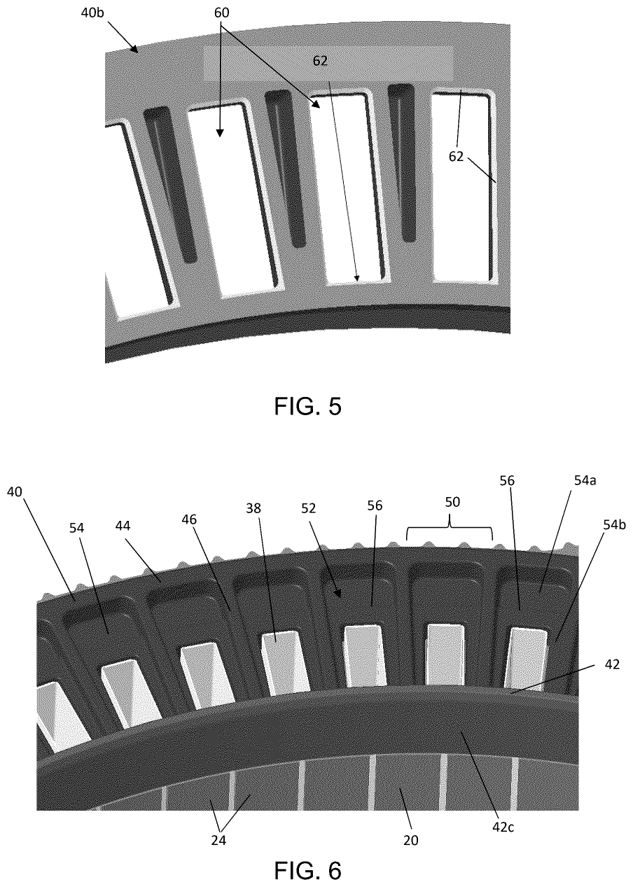

With particular reference now to FIG. 5, the bottom side 40b of the end ring 40 is generally flat with the openings 60 exposed on the bottom side 40b. The entire perimeter of each opening 60 on the bottom side 40b of the end ring 40 is bordered by a chamfer 62. This is the same chamfer 62 described previously in association with the radially-outward-facing surface 42d at the bottom side of the inner lip 42. The chamfer 62 is generally angled between about 45° and 75° (e.g., about) 60° relative to the bottom surface of the end ring 40, and extends about 0.5 mm to 1.0 mm upward from the bottom surface. Again, this chamfer 62 is designed to assist with insertion of the end ring 40 on the stator core 20 by preventing crumpling of the slot liner 38 as the end ring 40 is brought into position against the core 20. Specifically, as the end ring 40 is moved axially toward the stator core 20 during the assembly process, the slot liners 38 first engage the chamfers 62 around the openings 60. As the end ring 40 continues to move axially toward the core 20, the slot liners 38 slide along the chamfers 62, which direct the ends of the slot liners 38 slightly inward until the end ring 40 is brought into position against the core 20. Advantageously, the chamfers 62 prevent the slot liners 38 from engaging any blunt edges on the end ring 40, and thereby prevent crumpling or other damages to the slot liners 38.

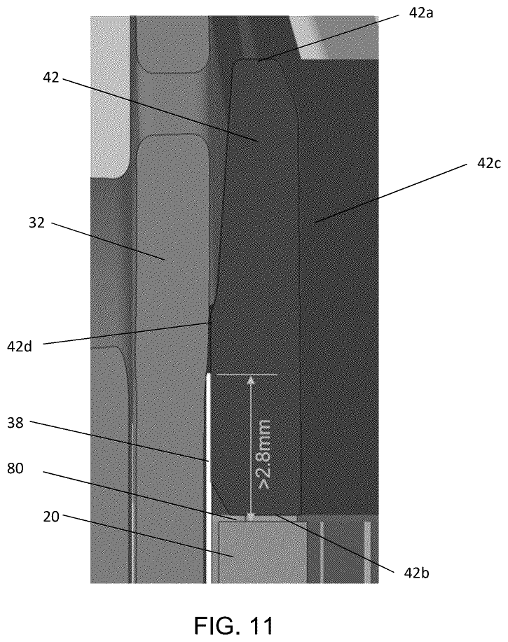

As shown in FIG. 6, when the end ring 40 is properly seated against the stator core, each slot liner 38 engages the entire perimeter of the associated opening 60 and extends through the opening 60 to the upper pocket compartment 52. The top edges of the slot liners 38 extend past the chamfers 62 and may also extend above the pocket floor 54. Specifically the top edges of the slot liners 38 extend about 2.8 mm or more axially above the stator core 20 (as illustrated in further detail in FIG. 11). In this position, the slot liners 38 extend longer than typical slot liners in other electric machines and have sufficient length to seal against the end of the openings 60 of the end ring 40. This seal is partly due to the chamfer 62 surrounding each opening 60 of the end ring 40. Accordingly, it will be recognized that a slot liner that extends at least 2.8 mm above the end face of the stator lamination is disclosed herein. However, if this dimension of the slot liner is too long, the end turns 34 of the windings 30 would have to be longer, and this would cause wasted cost for the copper wire and the slot liner material. Therefore, the slot liner 38 extending between 2.8 mm and 4.5 mm has been determined to be advantageous.

The flat bottom side 40b of the end ring 40 is useful in facilitating a seal with the flat end on the insertion side of the stator core. Preferably, the flatness (e.g., as defined by geometric dimensioning and tolerance (GD&T) such as ASME Y14.5) of the end of the stator core should be less than 0.4 mm and preferably around 0.1 mm (+/−0.05 mm). For the end ring, the flatness should be less than 0.7 mm and preferably about 0.4 mm (+/−0.05 mm). The material used to form the end ring 40 (e.g., PPS with 40% glass fill) advantageously allows for an insulative end ring with a flatness within the desired tolerance range.

### Ring Seals

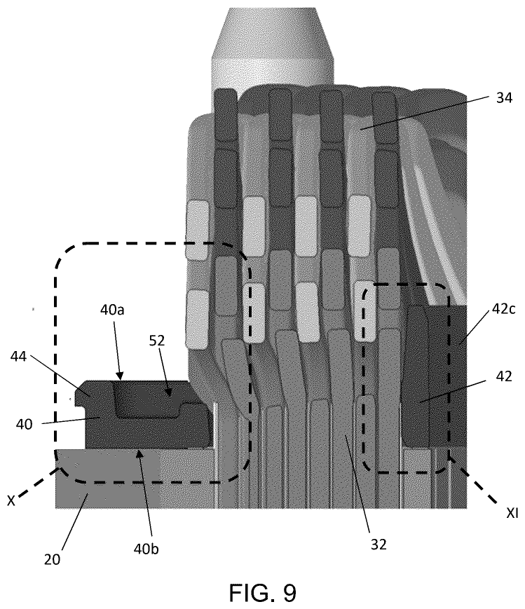

The inner lip 42 of the end ring 40 is sufficiently wide and strong to accept a lip seal 70 (best seen in FIG. 17; which lip seal may also be referred to as an “inner ring seal”). The lip seal 70 is located between a portion of the housing or a guide 19 of the stator 12 (see FIGS. 9 and 11) and the inner lip 42 of the end ring 40. The lip seal 70 is thus configured to seal the end ring 40 to the guide 19 (similar to that shown in FIG. 17 in association with end ring 41, explained in further detail below). The guide 19 may be a separate piece from the housing 18 or it may be a part of the housing 18. In FIG. 17, the guide 19 is shown as a separate piece.

Because the inner lip 42 is relatively wide, and because the inner lip 42 is positioned over the tips of the teeth 24 on the stator core 20, the teeth 24 of the stator core 20 mush have a tip depth that is slightly increased in order to allow the innermost wire in a slot 22 to be arranged further back (i.e., slightly radially outwardly) in the slot. Accordingly, the distance from the stator ID to the slot liner (see distance d in FIG. 7) is increased to 2.88 mm. However, it has been determined that this dimension d should typically be less than 4 mm. When the dimension d is greater than 4 mm, the slot fill of the stator may be compromised, and this will compromise motor performance and efficiency. Accordingly, the width of the inner lip 42 is generally limited to a width of less than 4 mm.

In at least some embodiments of the stator 12, an outer ring seal 74 (illustrated in dotted lines in FIG. 10) is also provided on the end ring 40 in addition to the inner ring seal 70. The outer ring seal 74 is positioned against the outside 44d of the outer edge of the end ring 40. The outer ring seal 74 may be band-shaped with a greater axial height than thickness or it may be an O-ring or similar-shaped sealing member. As illustrated in FIG. 10, the outer ring seal 74 is configured to be retained by and abut the lip 48 provided on the outwardly-facing-surface 44d on the outer edge 44 of the end ring 40. Accordingly, the outwardly-facing surface has a greater diameter on the axially-outward side (i.e., the upper side) of the outer lip 48 than the axially-inward side (i.e., the lower side) of the lip 48. The lip 48 provides a shoulder that engages the outer ring seal 74 and prevents it from sliding axially outward beyond the end ring 40.

The inner ring seal 70 and the outer ring seal 74 advantageously seal the inner and outer perimeters of the end ring 40. The inner ring seal is particularly advantageous and prevents oil from leaking into the air gap between the rotor 16 and the stator 12. The outer ring seal 74 is helpful in sealing the stator 12. The outer edge 44 and the amount of material in the outer edge 44 serves a dual purpose as it also prevents the end ring 40 from warping in the injection mold and cooling process, and assists in balancing the material from the ID to the OD of the end ring 40. A non-warped end ring 40 is pertinent for the bottom side 40b of the end ring 40 to be relatively flat and smooth enabling a solid seal provided by the sealant 80.

### Gasket

As discussed previously, a sealant is provided between the end ring 40 and the stator core 20. In at least some embodiments, the sealant is a liquid or gel-like material that is applied directly on to a surface of the end ring 40 or stator core. In at least some other embodiments, the sealant is a gasket 80 provided by an adhesive material applied between the bottom side 40b of the end ring 40 and the end surface of the stator core 20, wherein the gasket 80 is a unitary component that is applied to the end ring 40 or stator core 20 as a unit. The material used to form the gasket 80 (or sealant) may be, for example, a glue, adhesive, or a sealant material such as room temperature vulcanizing (RTV) silicone. Advantageously, the bottom side 40b of the end ring 40 and the end surface of the stator core 20 are flat and relatively smooth such that a solid seal is provided by the gasket 80.

As particularly shown in FIGS. 13 and 14, in at least one embodiment, the gasket 80 is provided by a double-sided sticky tape having a shape that is similar to that of the bottom surface 40b of the end ring. For example, the tape may include an inner perimeter edge 82, an outer perimeter edge 84, a plurality of radial ribs 86, and a plurality of openings 88, each of which is similarly sized to the bottom surface 40b of the end ring 40. Alternatively, the tape may only have a shape that matches the inner lip 42 of the end ring. Also, the tape may be provided as one annular ring or, alternatively, could be provided as multiple different sections such as, but not limited to, six (6) 60° sections.

During manufacture of the stator 12, the gasket 80 may be first applied to either the bottom surface 40b of the end ring 40 or to the end surface of the stator core 20. If the gasket 80 is a tape structure such as that shown in FIGS. 13 and 14, the tape may have a backing material on one or both sides to assist with installation. After engaging the first side of the gasket 80 on the first component (i.e., either the end ring 40 or the stator core 20), the backing material is peeled away from the second side of the gasket 80 and the second component is brought into engagement with the second side of the gasket. In this manner, the gasket 80 is used to provide an adhesive seal between the end ring 40 and the core 20.

Once the end ring 40 is in place on the stator core 20, the conductors 32 that form the windings 30 are fed through the end ring 40 and the slots 22 of the stator core 20. A bend the conductors 32 on the end turns 34 contact the ribs 46 of the end ring 40 which further helps to hold the end ring 40 in place against the tape/adhesive gasket 80 and the stator core 20.

### Filler Applied to End Ring

That stator further includes a filler material (e.g., varnish, epoxy or other resin material) applied to the stator windings and end ring 40. The filler material acts as an insulative bonding agent that serves to further seal the end ring 40 to the end of the stator core 20. The filler material is designed to adhere well to the slot liner 38, the end ring 40 and the existing insulation on the conductors 32 of the stator windings 30.

As noted previously, the radial clearance between the openings 60 of the end ring 40 and the slot liner 38 is approximately 0.1 mm to 0.3 mm. This dimension advantageously causes the filler material to wick into the cavity 66. If this dimension is smaller, the assembly of the end ring 40 on the stator core 20 is difficult to make without crumpling the slot liner 38. On the other hand, if this dimension is too large, the filler material will not wick (capillary action) in between the slot liner 38 and the end ring 40.

### Weld Side End Ring for Sealed Stator

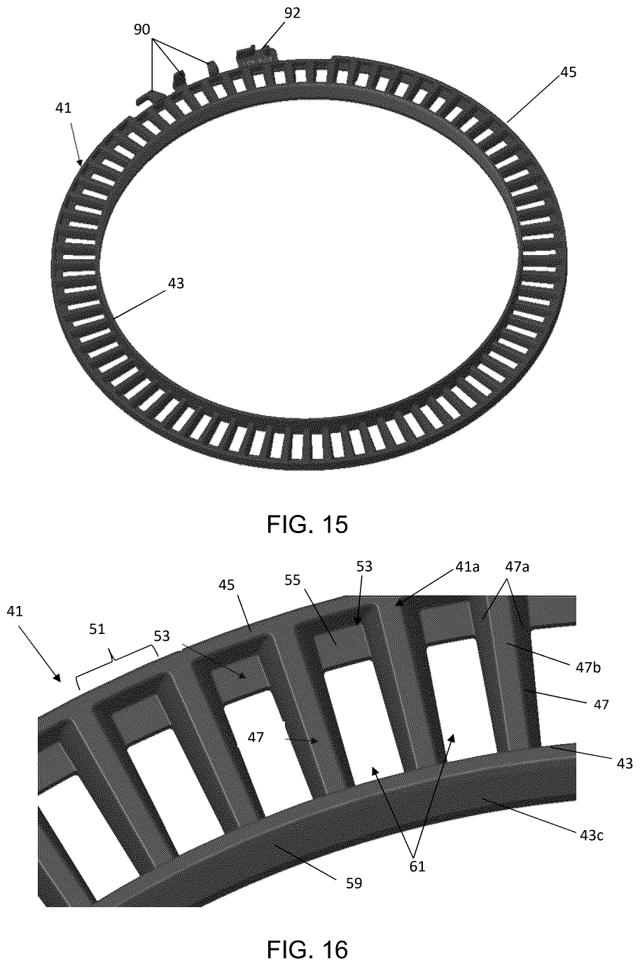

In addition to the above-described end ring 40 on the insertion side 14 of the stator 12, the stator is also equipped with an end ring 41 on the weld side 15 of the stator. The weld side end ring 41 is shown in association with FIGS. 15-18 and is similar to the insertion side end ring 40. Accordingly, the weld side end ring 41 is made of the same material as the insertion side end ring 40, and is similarly sized and configured for use with the slot liners 38, gasket 80, and filler material (e.g., epoxy or varnish) to seal the end ring 41 to the stator core 20. However, the weld side end ring 41 includes a few structural changes that make the end ring 41 specifically adapted for use on the weld side of the stator 12.

As best shown in FIGS. 15 and 16, the end ring 41 is a disc-shaped member that includes and inner perimeter lip 43, an outer perimeter edge 45, an axially-outward-facing side 41a (which may also be referred to herein as a “top side”), and an axially-inward-facing side 41b (which may also be referred to herein as a “bottom side”).

The axially-outward-facing side 41a of the end ring 40 includes a plurality of ribs 47 extending in a radial direction between the inner lip 43 and the outer edge 45. Each rib 47 is defined by opposing angled sides 47a that taper toward one another (e.g., at an angle of approximately 15°-30° relative to axial) and meet at a radially flat upper portion 47b. The ribs 47 split the end ring 41 into a plurality of contiguous (and overlapping) segments 51 arranged circumferentially around the entire circle of the end ring 41. Each segment 51 defines a pocket compartment 53 with an outer pocket floor 55 and an inner opening 61. A chamfer may be formed around the bottom perimeter of each opening 61 (similar to that shown in association with FIG. 5). Similar to the insertion side end ring 40, conductors 32 of the stator windings 30 are inserted through the openings 61 in the weld side end ring 41 and into the slots 22 in the stator core. As best shown in FIG. 18, the conductors 32 are bent around the ribs 47 and engage the ribs 47 at the locations where the conductor transitions from the axial in-slot portion to the end turn 34. Accordingly, the ribs 47 facilitate bending of the conductors 32 in order to form the welded end turns 35, assist in securing the end ring 41 to the stator core 20, and insulate the conductors 32 from the core 20.

With reference to FIGS. 16 and 17, the inner lip 43 is a generally cylindrical wall member that includes a substantially flat and smooth radially-inward-facing surface 43c configured to engage a lip seal 70 (see FIG. 17; not shown in FIG. 16). The bottom side of the radially-inward-facing surface includes a shoulder 59 that extends radially outward and is configured to engage the bottom of the lip seal 70. The lip seal 70 engages the guide 19 and provides a seal between the end ring 41 and the guide 19. In some embodiments the guide 19 is separate from the housing 18; in other embodiments, the guide 19 may be a contiguous part of the housing. Similar to the insertion side end ring 40, the weld side end ring 41 may also include an outer ring seal (not shown in FIGS. 15-18) that provides a seal between the outer edge 45 of the end ring 41 and the guide 19 or the housing 18. This outer ring seal may be provided by an O-ring, lip seal 70, or any of various other types of seals.

With reference again to FIG. 18, it will be recognized that the ribs 47 serve as radiused/angled plastic bumps that support the wires during the twist operation of the conductors 32 when forming the welded end turns 35. These plastic bumps may replace the expensive cuff finger tooling commonly used in twist formers As is known in the art, hairpin stator forming may involve insertion of this tooling (i.e., “cuff fingers”) which are located on the lamination and perform two tasks. First, on the insertion end of the stator, the fingers are used to stop the hairpins from being axially inserted too far and ground out to the stator lamination. Second, on the weld end of the stator, the cuff fingers support the wires during the hairpin twist operation. In the disclosed embodiments herein, these cuff finger features are combined into the end rings 40 and 41 by virtue of the ribs 46, 47. FIG. 12 illustrates how the ribs 46 prevent the hairpins from being inserted too far into the slots. FIG. 18 illustrates how the ribs 47 support the wires during the hairpin twist operation. The ribs 46 on the insertion side end ring 40 are more rectangular when compared to the ribs 47 on the weld side end ring 41, but are thinner circumferentially in order to reduce material usage. The axial height of the ribs 46 on the insertion side end ring 40 may also be different in comparison to the ribs 47 on the weld side end ring 41.

In addition to the foregoing, the weld side end ring 41 may further include features to hold a temperature sensor (not shown) for the stator 12. In particular, as shown in FIG. 15, three L-shaped hooks 90 are provided along the outer edge 45 of the end ring 41. The L-shaped hooks 90 are configured to hold the thermistor or thermistor wire in place: one hook feature to hold the wire axially upwards, one hook feature to hold the wire axially downwards, and one feature to hold the wire circumferential. Another feature is a clip 92 with a post to wrap the wire around for further strength.

While the end rings 40 and 41 have been described herein as similar rings with slightly different features, it will be recognized that in some embodiments, the end rings 40 and 41 may be identical. Moreover, features in the insertion side end ring 40 that were not shown or described as being present in the weld side end ring 41 may be incorporated into the weld side end ring 41, and vice-versa. For example, the shoulder 59 on the radially-inward-facing side/surface 43c of the inner lip 43 of the weld side end ring 41 could also be incorporated into the insertion side end ring 40. As another example, while the gasket 80 is not shown or described in association with the weld side end ring 41, it will be apparent that an identical or similar gasket 80 may also be used in association with adhering the weld side end ring 41 to the stator core 20.

### Method of Making Sealed Stator for Electric Machine

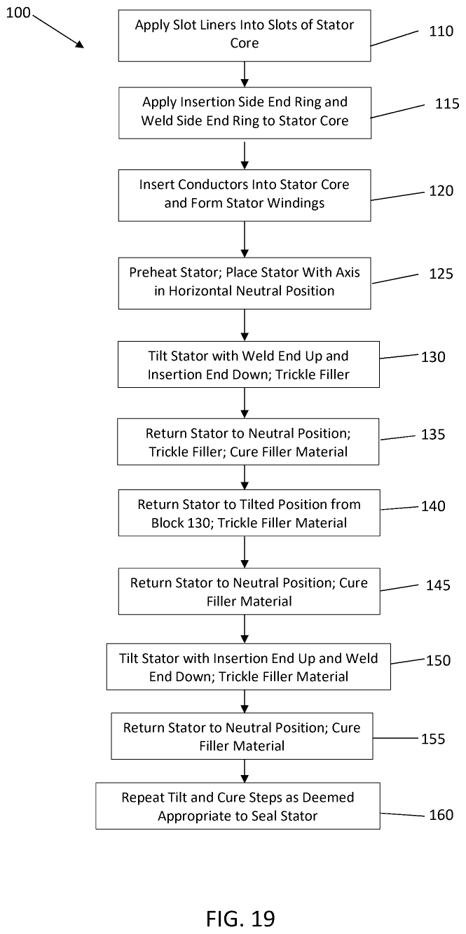

The design and arrangement of a sealed stator 12 has been described above with reference to FIGS. 1-18. A method of making the sealed stator is now described with reference to FIGS. 19-24. FIG. 19 is a block diagram 100 showing acts performed in association with the method. FIGS. 20-24 illustrate details with respect to various acts performed with the method.

As shown in FIG. 19, the method 100 begins with block 110 and placement of the slot liners 38 into the slots 22 of the stator core 20. As described previously, the slot liners 38 are inserted into the slots with the overlap portion of the slot liner at the back of the slot (i.e., the radially outward wall of the slot).

Next, the method continues with block 115 and application of the insertion side end ring 40 and the weld side end ring 41 to opposite ends of the stator core 20. As described previously herein, a gasket 80 such as that shown in FIG. 13 may be used to adhere one or both of the end rings 40, 41 to the opposing ends of the stator core 20.

Once the end rings 40, 41 are in place on the stator core 20, the method 100 continues at block 120, and the stator windings 30 are formed on the core 20. FIG. 20 illustrates an exemplary process for forming the windings. As shown in FIG. 20, the process includes first firming hairpin-shaped conductors 32 from lengths of copper wire, the hairpin-shaped conductors including U-turns 34 and straight legs 36. Second, the straight legs 36 are inserted into slots 22 of the stator core 20. Third, the ends of the legs 36 are twisted or bent such that a leg end of one hairpin in one slot is adjacent to the leg end of a different hairpin in a different slot. Fourth, the adjacent ends of the legs are welded together to form coils around the stator core, which coils form the stator windings 30.

With continued reference to FIG. 19, after the stator windings 30 are formed at block 120, the stator is ready for application of the insulative filler material (e.g., varnish or epoxy) to the stator windings and end rings 40, 41. As with most stator varnish trickle operations, the stator assembly is spinning during the trickle steps and the cure steps. Preparation for application of the filler material occurs at block 125 wherein the stator is pre-heated at a filler-application station and placed in a horizontal neutral position (i.e., the axis of the stator is arranged horizontally). FIG. 21 shows a stator 12 in this position at a filler application station 190 with a shaft 192 of the filler application station extending into the stator 12 in a horizontal position (i.e., as noted by arrow 199 in FIG. 21).

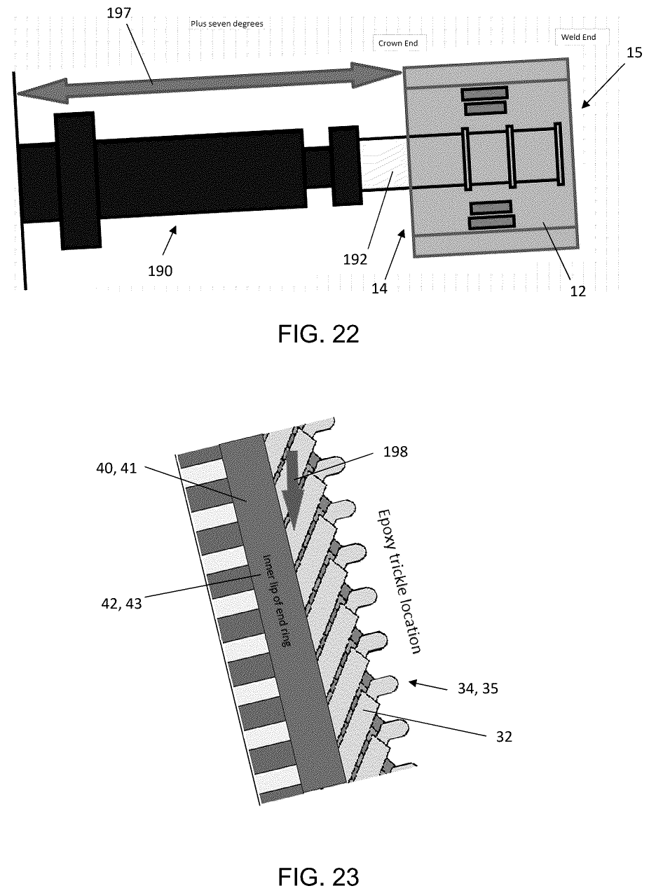

Next, at block 130, the stator is tilted upward in one orientation (for example weld end up, as shown in FIG. 22). The degree of the tilt may depend in part on the filler material used and the particular arrangement of the stator. It has been determined that an axis tilt of seven degrees (7°) is an effective tilt angle (as noted by arrow 197 in FIG. 22), but anything between 2 degrees) (2° and 50 degrees) (50° has also been determined to be adequate when using epoxy fill. During this step, filler material is trickled mostly on the higher end of the stator-both ID and OD for a first period of time (e.g., eighteen (18) minutes). The filler material is trickled onto the conductors 32 that form the end turns 34, 35 and capillary action cause the filler material to fill in between slot liner 38 and end ring 40, 41 (i.e., into cavities 66 as shown in FIG. 7), end ring 40, 41 and stator core 20, slot liner 38 and conductors 32, and slot liner 38 and stator core 20. The filler material in the cavity 66 is particularly advantageous and creates a solid seal between the conductors 32 and the openings 60 of the end rings. More specifically, filler material in the radially inner portion of the cavity 66 provides an advantageous seal to the ID and prevents oil from leaking into the rotor/stator air gap.

A plurality of trickle tubes are used to drop filler material onto the stator 12 at the filler application station 190. The trickle tubes include two inner diameter trickle tubes located directly above (i.e., vertically relative to) the inner lip 42, 23 of the end rings 40, 41, and two outer diameter trickle tubes located directly above (i.e., vertically relative to) the outer edge 44, 45 of the end rings 40, 41. The stator 12 is slowly rotated during the trickle process so that the trickle tubes cover the entire circumference of the stator during the first period of time. FIG. 23 illustrates the position of the end turns 35 and end ring 41 during trickle of the filler material. Arrow 198 illustrates that the filler material drops vertically downward due to gravity, contacts the end turns 35 and the end ring 41, and is spread throughout the various components on the end of the stator core.

Following application of the filler material for the first period of time, the method continues at block 135 of FIG. 19, and the stator is returned to a neutral position with the stator axis in a horizontal position (i.e., zero degrees). At this position, the stator is again trickled with epoxy for a second period of time along the ID and OD (4 places total) as the stator is rotated. The second period of time is shorter than the first period of time. For example, the second period of time may be one (1) minute. After the second period of trickle time, the filler material is either partially or fully cured. Curing the filler material may occur by applying heat (and/or air or light) to the filler material over some period of time

Next, the method continues at block 140 and the stator is tilted back to the same tilt as the previous tilt (e.g., 7° or whatever tilt was provided at block 130), and the higher end (i.e., the weld end) is epoxy trickled again on the ID and OD for a third period of time (e.g., one (1) minute) as the stator is rotated. At block 145, the method continues when the stator is then tilted back to the horizontal neutral position (i.e., zero degrees), and the stator is heat cured once again.

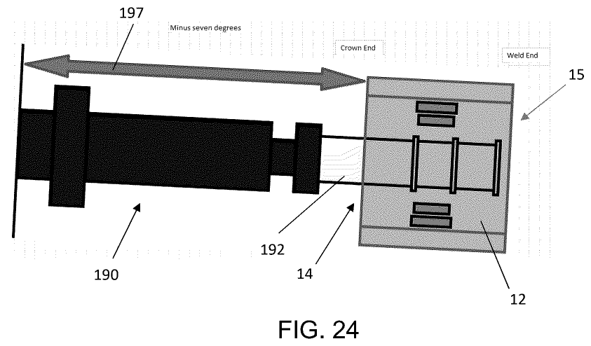

At this point, filler material is complete on one end of the stator 12 (e.g., the weld end), and filler material is next applied to the opposite end (e.g., the crown end). As noted in block 150, filler material is generally applied to the crown end in a similar manner to that of the weld end. For example, as shown in FIG. 24, the insertion end 14 of the stator 12 may be tilted upward (i.e., with the weld end 15 tilted downward) by a selected degree of tilt (e.g., axis 192 of the filler application station 190 tilted negative seven degrees (−7°) or other tilt degree opposite that used in association with block 130). The same process is then used to trickle filler material onto the end of the stator core for a fourth period of time as the stator is rotated. Depending on the desired amount of filler material to be applied, this period of time may be relatively long (e.g., eighteen (18) minutes) or relatively short (e.g., one (1) minute).

After application of the filler material, the process continues at block 155 and the stator is returned to the horizontal neutral position. At this point, the recently applied filler material is heat cured to set the filler material. Thereafter, as noted at block 160, any additional tilt and cure steps, such as those disclosed in association with blocks 125, 130, 135, 140 and 145 may be repeated for the opposite end of the stator (i.e., the insertion end 14). For example, each of steps 130, 135, 140 and 145 may be performed on both ends of the stator core. These steps are conducted as deemed appropriate by the manufacture of the stator to complete the desired seal between the end rings 40, 41 and the stator core.

It will be recognized that the end rings 40, 41 include advantageous structures when the application method 100 of FIG. 19 is used to apply the filler material. For example, as shown in FIG. 9 the outer edge 44 of the end ring 40 is made shorter than the inner lip 42 to allow the outer diameter trickle tubes to be located closer to the wires and face of the stator core 20. The inner lip 42, 43 is required to be long enough to seal to engage the lip seal 70 and the housing. As another example, the portion of the pocket compartment 52, 53 (see FIGS. 4 and 16) that extends to the radially outward side of the end rings 40, 41 serves to catch any epoxy overfill during the trickling process.

Although one or more embodiments of a sealed stator for an electric machine have been provided herein in associated FIGS. 1-24, it will be appreciated by those of skill in the art that other implementations and adaptations are possible. As one example, while the ribs 46, 47 between the pockets provide significant strength to the end rings 40, 41, they could also be designed shorter in axial height compared to the height of the outer edge. This would allow filler material over flow to flow from pocket to pocket before the filler material flows radially outward to the outer edge. As another example, the sides of the ribs 46 could also be angled, similar to the ribs 47 (see FIG. 16) to promote flow over the ribs instead of over the outer edge.

In addition to the foregoing, it will be recognized that aspects of the various embodiments described herein may be combined or substituted with aspects from other features to arrive at different embodiments from those described herein. Thus, it will be appreciated that selected ones of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the any eventually appended claims.

What is claimed is:

1. A stator for an electric machine, the stator comprising:
a stator core including a plurality of stator slots with axial openings to the slots;
windings positioned on the stator core, the windings including a plurality of interconnected conductors extending through the plurality of stator slots; and
an end ring coupled to the stator core, the end ring comprising a plurality of openings arranged circumferentially around the end ring, wherein the plurality of openings in the end ring are aligned with the axial openings to the stator slots; and
a sealant positioned between the stator core and the end ring.

2. The stator of claim 1, wherein the sealant is a sealing gasket.

3. The stator of claim 2, wherein the sealing gasket is provided by an adhesive tape structure.

4. The stator of claim 3 wherein the adhesive tape structure is provided by a double-sided sticky tape having a shape that is similar to an axially-inward-facing surface of the end ring.

5. The stator of claim 4 wherein the sealing gasket includes a plurality of radial ribs arranged circumferentially around the end ring and a plurality of openings positioned between the radial ribs.

6. The stator of claim 1 wherein the end ring includes an axially-outward-facing side and an axially-inward-facing side, wherein a chamfer is formed around a perimeter of each opening on the axially-inward-facing side.

7. The stator of claim 1, wherein the stator slots include axial openings, and wherein the openings in the end ring are greater in size than the axial openings to the stator slots.

8. The stator of claim 5, further comprising a plurality of slot liners arranged in the plurality of slots, the plurality of slot liners extending axially through the slots, the openings in the gasket, and through the openings in the end ring, each of the plurality of slot liners positioned between walls of a slot and the conductors extending through the slot.

9. The stator of claim 8, wherein each of the plurality of slot liners extend at least 2.8 mm in an axial direction past an end of the stator core.

10. The stator of claim 8, wherein each of the plurality of slot liners include an overlapping portion arranged along a radially outward wall of the slot.

11. The stator of claim 1, the end ring further comprising an inner lip extending around an inner diameter of the end ring, and an outer edge extending around an outer diameter of the end ring.

12. The stator of claim 11, further comprising an inner lip seal engaging the inner diameter of the end ring and an outer lip seal engaging the outer diameter of the end ring.

13. The stator of claim 1, further comprising a cured insulative filler material provided on the end ring.

14. The stator of claim 1,
wherein the end ring is a first insulative end ring positioned on a crown end of the stator core, and the sealant is a first sealant,
the stator further comprising a second insulative end ring positioned on a weld end of the stator core and a second sealant positioned between the stator core and the second end ring.

15. The stator of claim 14 wherein the first sealant is a first sealing gasket and the second sealant is a second sealing gasket.

16. The stator of claim 1, wherein the stator is comprised of a bonded lamination stack.

17. The stator of claim 1, wherein the end ring is comprised of a high glass filled plastic material, and wherein an axially-inward-facing side of the end ring has a flatness of less than 0.7 mm.

18. The stator of claim 1 further including a pocket floor and an outer edge and the outer edge has a ring shape which extends outwardly axially from the pocket floor.

19. A stator for an electric machine, the stator comprising:
a stator core including a plurality of stator slots with axial openings to the stator slots;
windings positioned on the stator core, the windings including a plurality of interconnected conductors extending through the plurality of stator slots; and
an end ring adhesively bonded to the stator core, the end ring comprising a plurality of openings arranged circumferentially around the end ring, wherein the plurality of openings in the end ring are aligned with the axial openings to the stator slots.

20. The stator of claim 19 wherein the end ring is adhesively bonded to the stator core with an adhesive gasket, the adhesive gasket comprising a plurality of openings aligned with the plurality of openings in the end ring and the axial openings to the stator slots.
